(19) United States
(12) Patent Application Publication
(10) Pub. No.: US 2002/0013638 A1
(43) Pub. Date: Jan. 31, 2002

(54) Procedure and apparatus for control of a component of a textile machine with a plurality of similar, adjacent workstations

(76) Inventors: Jurgen Gaukler, Stuttgart (DE); Mario Maleck, Kipfenberg (DE)

Correspondence Address: STEPHEN E. BONDURA, DORITY & MANNING, P.A., P.O. BOX 1449, GREENVILLE, SC, 29602-1449, US

(21) Appl. No.: 09/753,994

(22) Filed: Jun. 8, 2001

(30) Foreign Application Priority Data
Jan. 4, 2000 (DE) 100 00 146.7

(51) Int. Cl. G06F 19/00

(52) U.S. Cl. 700/130

(57) ABSTRACT

A process and apparatus are provided for controlling components of individual work stations of a textile machine wherein the textile machine includes a plurality of adjacent such work stations. The work station components are run at a first speed during normal operation. A time period is established at the start of a voltage loss to the components. At the conclusion of this time period, the components are shut down. The components assume a second set speed as they run down during the time period beginning at the start of the voltage loss. Upon the voltage loss, an auxiliary current source is activated and the speed of the components which are supplied with auxiliary voltage from the current source is reduced in a controlled manner with the aid of a control program.

The present invention concerns a process for the control of a component of a textile machine, in accord with the generic concept of claim 1 as well as concerning an apparatus for the execution of said process.

In the case of modern textile machines, the customary practice is to provide components for the control of the complex process at each work station. These components themselves, are controlled with the aid of individual regulators which in turn are in communication through a bus system with an over-all control center (EP 0 385 530 A1). This known arrangement has the capability of controlling the startup of the components of a workstation as well as correcting such faults as arise. During the operation of a textile machine, from various causes, long or short term power failures can occur and the machine is deprived of the current necessary to carry on an orderly operation.

The essential purpose of the present invention is to create a process and an apparatus of such a nature, that during short term power failures, the flow of production need not be cut off or shutdown. In accord with an additional purpose, the achievement is sought, that following longer voltage losses or breakdowns, the workstations can be restored to operation in the shortest possible time.

The principal purpose is achieved by the features of claim 1. By preset by input of specified speeds of rotation and the presetting of a time period for the deceleration of the various components, the speeds of said components during this deceleration can be maintained in a defined sequential manner while the required relative speeds are retained at such a level that an orderly operation remains possible. By this means, the produced material, for instance, a thread, does not deteriorate in quality.

If, before the expiration of the specified time period, the necessary voltage is restored, then, in accord with the invention as stated in claim 2, the components in controlled or regulated manner come back up to their operational speeds, without the necessity of taking an operational interruption as a necessary evil. This corrective action assures, that the relative speeds of the said components among each other necessary for an orderly production always remain in effect not only during a reduction of speed, but also during a subsequent acceleration.

Advantageously, the period of time, during which the speed reduction takes place in a controlled manner, is determined in accord with claim 3 and/or claim 4.

In order to assure, that, independent of their individual inertias, the components can accelerate properly, it is an advantage, if, within the invented formulation of the present process, the acceleration does not occur from a constant speed phase, until after a delay for constant speed conformation is established by all components in accord with claim 5.

The auxiliary current supply, which is delivered during a short-time power loss, for the purpose of bridging over the no-current spell, can be produced for a short, determined time from the momentum of the still running textile machine. Thus, those components, which determine, or influence, the loss of the products produced on the machine during the power drop out—the products being, for instance, a fiber band or a thread—hold said products in a desirable speed relationship to each other. The momentum, of course, which serves as this auxiliary energy source, loses more and more energy i.e. speed, as the power loss continues. Thus, such a current can be maintained only for a short period, and is designated for control and drive of each component, which component contributes to an essentially unchanged product. In accord with the invention, on this account, upon the expiration of a first period, during which the components in a controlled or regulated manner are slowed in rotational speed, then, as taught in claim 6 and possibly in claim 7, the components with the greatest speed are brought to a stop. This allows the textile machine to be brought in the quickest way into a state, from which it can be started up again in a controlled or regulated manner. Besides relying on the momentum, for instance the auxiliary energy can be made available by batteries or by a lagging motor of the system or by a neighboring machine acting as yet another auxiliary energy source.

In accord with the invention, an apparatus described in claim 10 serves for the execution of the described process. A voltage monitor continually checks the voltage of the current supplied by the utility network and signals the control system of any deviation from the specified voltage, so that the control equipment can react immediately to a loss of voltage, and the components can wind down in a controlled fashion. The two set RPM's provide the range of the speed of rotation, which must continue through the span of time set by the control input. In this way, the of the speed curve from component to component can vary. The manner, that is, the downward curve, of the speed reduction is determined in dependency of the chosen set rotational speeds by a program which was previously input into the control apparatus.

When the required voltage is again available, then an acceleration of the components is introduced. This acceleration is undertaken in accord with claim 11 in a controlled or regulated way, so that the properties of the produced products are not changed. In order to provide a mutual accommodation phase to the components to be accelerated, and to give them sufficient time to be able to follow the acceleration independently of their inertial delay in the required manner, the time-control mechanism is advantageously constructed in accord with claim 12.

If the prescribed time interval has run out, then the speeds, such as were required for a proper production, can no longer be maintained. A reacceleration of the components now has no point, since the required speed ratio between the individual components has been destroyed, even if the required voltage had been renewed. In order to once again be able bring the production up in an orderly manner, in accord with the invention, claim 13 and/or claim 15 provide, that the components first, as quickly as possible, are brought to a stillstand, so that the combination of the components, in a regulated manner, can be accelerated from said stillstand and brought up to production speed.

If the components and the individual or central apparatus are connected together by a field bus-system, then a very rapid and simple communication between one another by means of data exchange is possible.

If one or more or the components signal to the individual or central control apparatus, that certain conditions, such as, the achievement of a specified rate of rotation or a set rotational ratio to other components has been met, then a particularly uniform and rapid acceleration of the components can be achieved.

The present invention enables, in a very simple way, the reduction of the idle time periods of the textile machines of the previously mention type. This is achieved in that, short time failure of voltage does not lead immediately to shutdown of the machine, but rather that in such a case the machine, as long as a specified time interval is not overstepped, can be caused to carry on with production, even at a declining speed. This continues until the components, either by renewed application of the required voltage, regain their normal operational speed, or, upon continued absence of voltage, the components are brought to the idle state as quickly as possible. In the latter circumstance, the components are prepared, when current is once again available, to be immediately set into operational performance in the usual manner.

Embodiments of the Invention are Described and Explained in Greater Detail with the Aid of Drawings. There is Shown in:

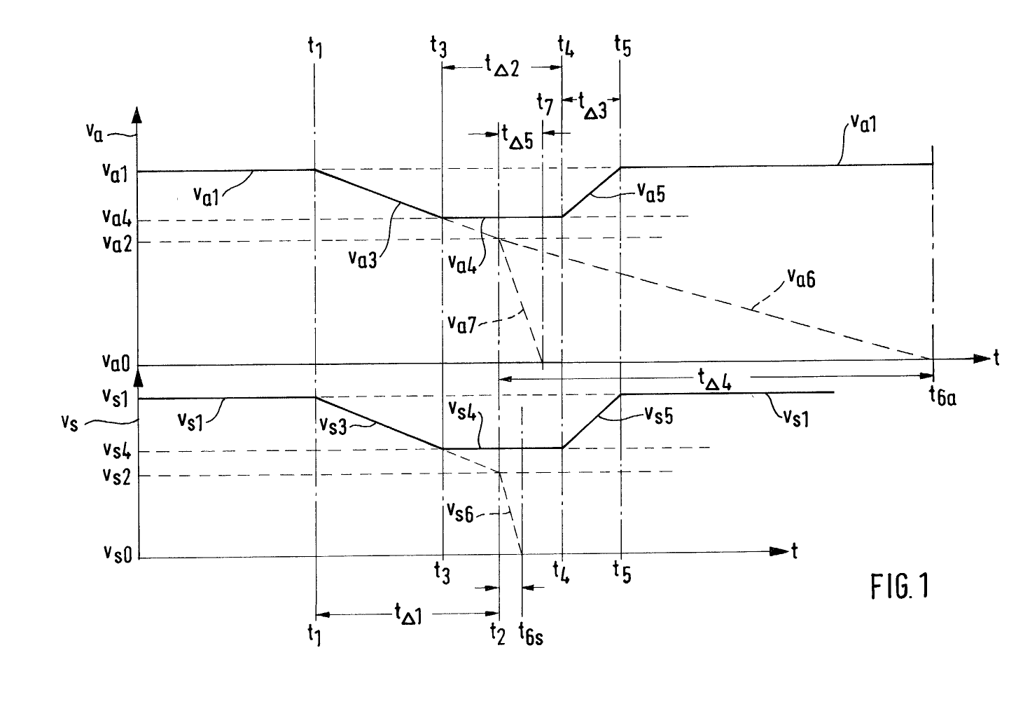

FIG. 1 a diagram of a continuous speed curve of a controlled component in accord with the invented process, and

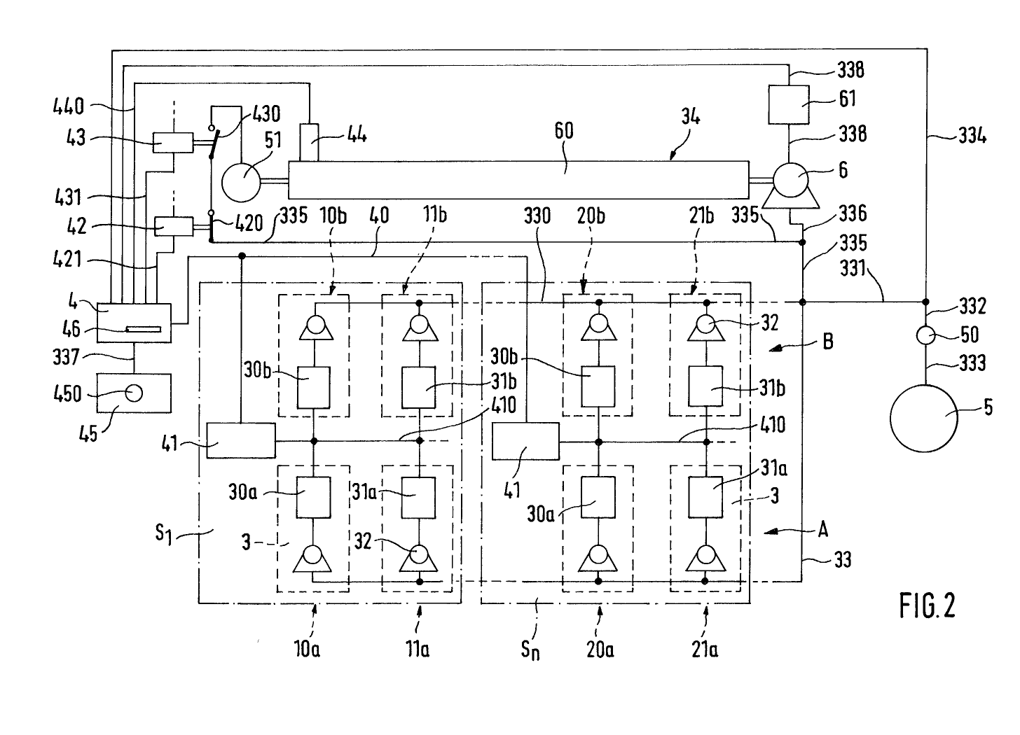

FIG. 2 a schematic presentation of the construction of the apparatus in accord with the invention.

The process, in accord with the invention, can be applied, in corresponding ways, to various textile machines. This is especially true if these machines exhibit a plurality of similar workstations. This is the case with such as ring-spin machines, conventional or unconventional machines, for instance open-end, wind-up, or spool machines. Even in the case of any one of these textile machines, the execution of the process described in the following in detail is not based on a special design of one such machine. For example, an open-end spinning machine need not be designed as a rotor spinning machine. The invented process further allows its use with friction spinning machines, electrostatically operating spinning machines or with air spinning machines or the like.

Before the invented process is explained, first, with the aid of FIG. 2, the essential elements should be described, with which such a process can be carried out.

Independent of the special designs of one of the above mentioned textile machines, these possess at least a multiplicity of workstations 10a, 11a . . . , 20a, 21a along a longitudinal side A. However, in some cases, as is shown in FIG. 2, on the second longitudinal side B of the machine, a further multiplicity of such workstations 10b, 11b . . . , 20b, 21b . . . , are provided.

For simplicity's sake, examples in the following, as a rule, will be essentially referred to the workstation 10a. The other workstations 10a, 11a . . . , 20a, 21a . . . , 10b, 11b . . . , 20b, 21b . . . of a generically designed textile machine are all built equally.

The workstation 10a possesses a plurality of controlled components 3, of which, essentially one individual component 3 is shown, in order not to cause the presentation in FIG. 2 to be too cluttered.

In the concept of the present invention, the word “component” is to be understood as that apparatus which is controllable and thereby can influence the loss of the product in various manners. It is obvious, that in accord with the characteristics of the textile machine, these components 3 can be designed in various manners. Even in textile machines of the same kind, for instance, in a open end machine constructed as a rotor spinning machine, these 3 components may be of different design, which design, among other things, is dependent upon the characteristics of the machine and the varied degree of its automation.

In order to clearly state, what should be understood by a component 3 in the concept of the present invention, in the following this will be explained in the example of an open end spinning machine, even if the components 3 and the open end spinning machine are not shown in detail. Such an open end spinning machine possesses a feeding apparatus, for the forwarding of a fiber band to a disintegrator, by means of which a fiber band is dissociated into individual fibers, which fibers then proceed to a spinner element wherein the said fibers conducted thereto from the disintegrator are bound into the end of a thread. This thread is continually removed by means of a thread withdrawal apparatus as the thread is pulled from the spinner element and is conducted further to a spool apparatus for the formation of spool. In the case of open end spinning machines, then, to be regarded as components in the concept of the invention, are the said apparatuses, namely the feed apparatus, the disintegrator, the spinning element (spinning elements), the thread withdrawal apparatus as well as the spool apparatus.

Further auxiliary apparatuses or components, such as, for instance, one of the band conducting means before the feed apparatus, a thread delivery device as well as an auxiliary apparatus for the driving of the spool during the startup or beginning phase are also, as a rule, additionally provided.

Where the present invention is concerned, it is also of no concern, as to whether or not the components 3 are installed in the work station 10a of the textile machine or whether one (or more) of these components 3 is placed on a mobile service device (not shown) which travels along the longitudinal side of the machine, or yet the component 3 is driven by a motor placed temporarily on a such a service device.

If, again, per workstation 10a . . . a plurality of components 3 are provided, this does not mean, that the invented achievement must be exercised in the case of all components in the said workstation 10a. and that all the named components 3 must be controlled in the same way and in accord with the following process which is about to be described. In accord with and in respect to the design of the workstation 10a . . . and of its components 3, it can suffice if simply one or two components 3 of said workstation 10ₐ are controlled by the here disclosed processing method.

The controlled connections are schematically presented in FIG. 2. In accord with the embodiment shown in this figure, it is indeed presupposed, that the textile machine is comprised of a multiplicity of sections S₁ to Sₙ. However this is not necessarily a presupposition that the invented process can be carried out in the case of textile machines of the named type that have no more than simply a single section S₁.

Now according to the embodiment shown in FIG. 2, a machine central control apparatus 4 is provided, with which is connected, through a bus system 40 per section S₁ . . . Sₙ to each section control apparatus 41. Each of these section control apparatuses 41 communicates through a bus system 410 with a plurality of individual control apparatuses, 30a, 31a . . . , 30b, 31b . . . In this way, the individual control apparatuses 30a, 31a . . . on the longitudinal side A and the control apparatuses 30b, 31b . . . on the other side B of the machine are respectively placed beside one another.

Each of the depicted components 3 possesses, besides the individual control apparatuses 30a, 31a . . . , and/or, 30b, 31b a drive 32. The drive 32 of the various workstations 10a, 11a . . . , 20a, 21a . . . and 10b, 11b . . and 20b, 21b . . . are connected by a line 33 and/or 330 as well as other lines 331, 332, 333 with a main source 5, which main source is, as a rule, the utility network. Between the line 332 and 333 is found a voltage monitor 50, which, by means of a line 334 is in communication with the central control apparatus 4. Voltage monitor 50 continually watches over the voltage of the main source 5.

The central control apparatus 4 possesses an input arrangement 46, the purpose of which will be explained later. Furthermore, the central control apparatus 4 (in accord with FIG. 2 by an interconnection line 337) is controllingly combined with a time control 45 which is integral with an adjustment controller 450.

During operation of a textile machine, for whatever reasons, short or long term interruptions of current can occur, in which case, the necessary voltage for the orderly operation of the machine is no longer available. In a case in which such a voltage failure lasts for only a very short time, to avoid a shutdown of the textile machine and therewith a loss of production, a short term availability of an auxiliary voltage has been provided for. This auxiliary voltage is produced for a short, specified time, for instance by the momentum of the still running textile machine.

The said auxiliary voltage, during this time period, can hold those components 3, which influence the loss of the textile machine products—these products being a fiber band or a thread—at such a level of speed and in such a speed ratio, one to the other, that there arises no great or noticeable deviation of the properties of the products from normal condition. Since the momentum of the present embodiment, which delivers the said auxiliary current, is now continually losing speed, for a limited time a voltage is maintained, such as is necessary for the control and the drive of these components 3 to effect the manufacture of a product essentially unchanged in its characteristics.

In order to bridge over short power failure times, in accord with the embodiment shown in FIG. 2, with the drives 32, the components 3, in addition to the main current source 5, are permanently in connection by line 335 to an auxiliary current supply source 51, this being in the form of a generator. Or, this auxiliary current source 51, at the occurrence of a voltage drop-out is connected with the drive 32 of the component 3.

The auxiliary source 51 stands in connection with the drive 32 of the components 3 through a normally closed contact 420 of a relay 42, as well as through a normally open contact of an additional relay 43. The relays 42 and 43, which themselves control the auxiliary current source 51, by means of a line 421, 431 are controllingly connected with the central control apparatus 4. The respective second connection of the relays 42 and 43. as well as of the further apparatuses, for instance the drives 32, because of clarity of the drawing, is not shown. These connections are made, however, in a conventional manner.

In order to drive the generator, that is, the source of auxiliary current, provision has been made that a drive 6 is connected with the main current source 5 by means of a line 336. Drive 6 drives an apparatus 60 which incorporates a great weight. The auxiliary current source 51 is permanently driven by this apparatus 60, or at the least, a driving connection with apparatus 60 is made upon the occurrence of a voltage loss.

In the case of an open end spinning machine the advantageous possibility exists of designing the said apparatus 60 as a shaft, this shaft conveniently being an integral part in common with the thread withdrawal apparatus of all workstations 10a, 11a . . . , 20a, 21a . . . of the longitudinal side A or all workstations and 10b, 11b . . . and 20b, 21b . . . of the longitudinal side B of the machine. This shaft extends itself over the entire length of the textile machine and thus also over all of the sections S₁ . . . Sₙ and possesses on this account a relatively high momentum, and hence also inertia, which can be put to use for the drive of the auxiliary source 51.

The drive 6 is controllingly connected by line 338, in which, as seen in FIG. 2, an individual control apparatus 61 is interposed, to the central control apparatus 4.

In accord with the design of the textile machine, it is possible, that some of the control functions are controlled through the section control apparatus 41, even though, in most cases it is advantageous to have the control run through the central control apparatus 4.

Now that the construction of the apparatus has been described above, which apparatus serves the carrying out of the invented process, with the aid of FIGS. 1 and 2, the process itself will be explained on the basis of an open-end spinning machine.

It is assumed, that the apparatus 60 in the depicted example, represents the driven shaft of a thread withdrawal apparatus, and is thus, likewise designated as a component 34 in the concept of the invention. Furthermore, for the example to be described, it is taken for granted that the elements concerned include the component 3 with its drive 32 representing the feed apparatus of an open-end spinning machine.

During normal production, in an open-end spinning machine, the component 3, formed by the feed apparatus is driven by the drive 32 with a first speed vₛ₁, while the thread withdrawal apparatus, formed from the component 34 (i.e. apparatus 60) is driven at another first specified speed, namely vₐ₁ (FIG. 1). These two set speeds. vₐ₁ and vₛ₁ remain in an unchanging, specified speed ratio to one another.

By means of this speed ratio between first, the feed through the feed apparatus (component 3) of a fiber band which is to disintegrate into individual fibers, to the openend spinning element, and second, the withdrawal of the thread—which has been spun from said fibers—by the thread withdrawal apparatus (component 34), there arises the thickness of the produced thread. In order to assure a constantly uniform thickness of thread, during the production of this thread, this speed ratio must be upheld without change.

FIG. 1 shows in a diagram, as ordinate, both the speed vₛ vertically for the feed apparatus (component 3) and vₐ for the speed at the thread withdrawal apparatus (component 34) shows horizontally as abscissae the elapsing time t. For the factors of the speed ratio respectively, in FIG. 1, vₛ₁ represents the set speed for the component 3 and vₐ₁ the set speed for the component 34.

In order to be able to drive the different components 3 and 34, which are of integral importance for production, with the required operational speeds (that is, set speeds vₛ₁ or vₐ₁), within given tolerance limits, an essentially constant operational voltage is necessary. If the supply voltage sinks below these tolerance limits, then the maintenance of the required speeds and their inter-component ratios can no longer be held, that is, the voltage relationships cannot be sustained.

In the embodiment shown in FIG. 1, the assumption is, that at time t₁, the current normally supplied through the main utility source 5 drops out, or at least its voltage falls below a certain specified threshold. If this is the case, then this situation is caught by the voltage monitor 50 (FIG. 2), and the central control apparatus 4 is signaled. Thereupon, with the aid of the relay 43 and its now closed contact 430, the auxiliary current source 50 kicks in and the controlled slow-up of the machine is initiated. This is depicted in FIG. 1 by the downward sloping speed vₐ₃ (for the thread withdrawal=component 34) and by vₛ₃ (for the feed drum=component 3). In accord with the auxiliary current source in use, this can remain continually in closed connection and in the case of a voltage drop-off is self actuating.

The slope of the curve is determined by the central control apparatus 4 and depends on the two set speeds vₐ₁ and vₛ₁ during normal production conditions on the one hand and on vₐ₂ and vₛ₂ as the lower threshold limits for sustaining the production as well as the time period t_{Δ1} between first the mentioned time point t₁, at which the voltage failed and the speed reduction set in, and second, the cutoff time t₂ at which the controlled reduction in speed (see the declining speeds vₐ₃ and Vₛ₃) is to be ended.

For the controlled speed reduction, upon the dropout of the operational voltage, that is, at point in time t₁, the time controller 45 is switched in by the central control apparatus 4. In this time controller 45, the time period t_{Δ1} and the associated cutoff point t₂ are stored.

During the reduction of the speeds vₐ₃ and vₛ₃, the speed-ratio remains constant in the time period after the loss of power to the components 3, which components influence the loss of thread. That is to say, the speed ratio is only changed to such a measure, that the loss of the thread remains, after as before, unchanged.

The speeds vₐ₃ and Vₛ₃ necessary for the controlled, or in some cases, regulated running down of the components 3, are under the control of the central control apparatus 4. Contributing to this purpose, a program is input into the central control apparatus 4, which program, before production starts, is in the form of a chip or in some cases, another mobile data carrier (for instance, CD-ROM, diskette, etc.) and is so entered into the control apparatus 4. To allow this, the said controller 4 possesses the mentioned designed input apparatus 46 (FIG. 2), for instance, taking on the form of a receiving slot. The program can also be transmitted over a bus system, serial communication means, or the like.

Besides this program, in a similar manner, before the start of production, the following properties are input into the central control apparatus 4:

set-speed vₐ₁ , which, with the aid of the control apparatus 61 and the apparatus 60 (component 34) is achieved by means of drive 6 for the thread withdrawal,

the set-speed vₛ₁ for the feed apparatus (component 3) controlled by the individual control apparatuses 30a, 31a, 30b, 31b, . . . and achieved by means of the drive 32.

These set speeds vₐ₁ and vₐ₁ should be maintained during normal production. Furthermore, the time period t_{Δ1} as well as the set speeds vₐ₂ and vₛ₂ are similarly preliminarily input. The input is inserted with the aid of the adjustment device 450 of the time control apparatus 45. The input data so described, should be possessed by the components 3, 34 at the run out time of the time interval t_{Δ1}, which on the curve of FIG. 1, is marked as the time termination point t₂ for the machine slowdown period.

The program stored in the central control apparatus 4 computes from the stored set speeds vₐ₂ and Vₛ₂ as well as the previously input time interval t_{Δ1} the course of the declining speed vₐ₃ of the component 34. The said apparatus 4 also computes from the stored set speed vₛ₁ and vₛ₂, and again from the time interval t_{Δ1}, the course of the declining speed vₛ₁ of the component 3.

Experience has shown, that for the time period t_{Δ1} , as a rule, a time of ca. 1 to 3 seconds is advantageous. However, this time period t_{Δ1} can be chosen to be just that much greater, the higher the original speed lies, that is the set speed vₐ₁ and Vₛ₁. Conversely to this, the time period t_{Δ1} must be reduced by just that much the lower the original speed lies, that is the set speeds vₐ₁ and vₛ₁ . Further the elapsed time of the time period t_{Δ1} is dependent on the value of the lower speeds vₐₛ and Vₛ₂ in comparison to what the value of set speeds vₐ₁ and vₛ₁ are. Since the under set speed vₐ₂ and vₛ₂, as a rule, are not free to be chosen, but are dependent up the type of textile machine, then the time period t_{Δ1}, can be determined in most cases in dependency of the upper set speeds vₐ₁ and vₛ₁.

If, before the reaching of this cutoff time t₂ at a time t₃ during the time interval t_{Δ1}, the voltage monitor 50 perceives and announces a renewed availability of a normal voltage within the previously set tolerance limits, then the central control apparatus 4, by means of the section controller 41, controls the individual control apparatuses 30a, 31a . . . and possibly 30b, 31b . . . as well as 61 in such a way, that, while yet maintaining the normal operatively governing speed ratios, all components 3, 34 are once again accelerated up to their operating speed (see increasing speeds vₐ₅ and vₛ₅). To allow this to happen, however, a time period t_{Δ3} is necessary, the length of which is dependent upon the speed which the component 3 at the time has achieved. The sooner the normal voltage is available, that is, the nearer time t₃ lies to time t₁, just so much nearer can the time t₅ approach t₄. The time t₅ is that time at which the component 3 has again reached its respective set speed vₐ₁ and vₛ₁. The time t₄ is that time at which this running up of speed begins. The nearer t₅ approaches t₄, advantageously, the shorter is the time period t_{Δ3}.

The speed changes of the individual components 3, 34 during the time periods t_{Δ1} and t_{Δ3} (between the times t₄ and t₅) is carried out with the components 3, 34 essentially in synchrony with one another, yet in all cases, this is neither required nor desired. If, in the case of an open-end spinning machine, for instance, during the start phase, a section of thread was produced with increased speed of rotation, in order to increase the start of spinning assuredness, then, for example, the spinning element (not shown) would be greatly accelerated out of all proportion.

If, the voltage required for faultless spinning within this prespecified time period t_{Δ1} cannot be achieved, and which period t_{Δ1} was empirically transmitted and by means of the adjusting apparatus 450 was input as a prespecification into the central control apparatus 4, that is input therein or into the integrated time control apparatus 45, then a further, controlled, deceleration of the machine is of no further value. The reason for this is that a restoration of the necessary speed and thereby an orderly production is no longer possible. On these grounds, after reaching this predetermined time t₂ at the end of the time span t_{Δ1}, the said auxiliary current source 51 is put out of operation. This can be carried out by:

control through the central control apparatus 4 and its associated time controller 45,

mechanical decoupling of the auxiliary current source 51 from the component 60,

electrical interruption of the line 335 by means of one or the other contacts 420 and/or 430 by appropriate control of one or the other of the two relays 42 and/or 43, and

other means, such as interruption of the data exchange between the components 3, 34 and the individual control controllers thereto assigned, i.e. 41, 61.

Components 3, 34 thus run in an uncontrolled manner (see speeds Vₐ₆ and Vₛ₆ in FIG. 1), slowing down to their respective stopping points vₐ₀ or vₛ₀ which they reach at different times t₆ₛ , and t₆ₐ, these times being dependent upon the respective inertia of components 3, 34.

The above explained process, along with the previously described apparatus can be altered within the framework of the present invention in a multitude of ways, in particular by the exchange of individual or multiple features with equivalents or by other combinations of features and their equivalents. Thus, it is not entirely necessary, upon the restitution of the full operating voltage, to immediately introduce the acceleration phase (see time period t_{Δ3}).

In accord with the embodiment shown in FIG. 1, this reacceleration (see speeds vₐ₅ and vₛ₅) does not occur immediately sequentially to the reduction of the speeds (vₐ₃ and vₛ₃). The reacceleration occurs only upon the interposing of a second time period t_{Δ2}, during which the components 3, 34 are driven together with an essentially constant speed vₐ₄ and Vₛ₄. This assures, that independent of the subsequent acceleration of the weights of the components 3, 34 after the time t₄ acceleration can be again carried out in a safe, desirable manner, which means under control or regulation.

Components 3, 34 can, under these circumstances, be raised to the necessary set speeds vₐ₁ and vₛ₁ for normal production,at which they arrive at time t₅. This second time period, t_{Δ2} is carried through in the same manner as the first time period t_{Δ1} before the start of production and is regulated with the aid of the adjustment controller 450 of the time controller 45. This second time period t_{Δ2} begins to run as immediately, when the voltage is restored, even before the run-out of the first time period t₁.

As may be inferred from the speed vₐ₆, the time period t_{Δ4}, from time t₂ on, within which period the component 34 has reached its lowest set speed vₐ₂, until stillstand time t₆ₐ is reached, vₐ₀ has endured for an extensive time, which is dependent upon the momentum of the component 34. In order to shorten the time to stillstand, vₐ₀ and vₛ₀, provision may be made, if desired, that instead of, or in addition to, the shutdown of the auxiliary current source 51, the components 3, 34, can be quickly stopped by the activation of brakes provided for this service. In this way, the time period is made short, during which no defined speed ratios are in effect between the driven components 3, 34, so that when stilistand (vₐ₀ and vₛ₀) is attained, once again the same ratios between the components 3, 34 come into effect. Thus, upon the occurrence of the restoration of normal voltage ratios for the startup, little time has been lost, since it is no longer necessary to wait out the inertial running of the components 3, 34, before the start of spinning can be carried out in the manner elsewhere described. As FIG. 1 in the example of the curve of the speed vₐ₇ for the thread withdrawal (component 34) shows, the approach to stillstand vₐ₀, instead of first running to time t₆ₐafter a passage time of tₐ₄, advantageously achieves an essentially shortened time period tₐ₅ to reach time t₇.

After the components 3, 34 of the various work stations 10a, 11a . . . , 20a, 21a . . . and possibly, 10b, 11b . . . , 20b, 21b . . . have come to a stillstand vₛ₀, ᵥₐ₀, the operational process can once again be taken up, which, in the case of an open-end spinning machine is carried out by a simultaneous, common spinning startup procedure at the combined work stations 10a, 11a . . . , 20a, 21a . . . , 10b, 11b . . . , 20b, 21b . . . , or alternatively, by a sequential spinning startup beginning at a work station 10a, 11a . . . , with the others following thereafter. The startup procedure is executed in the customary and known manner, and can be undertaken just so much earlier, as the components 3, 34 more quickly reach their condition of stillstand vₐ₀, vₛ₀.

The said brakes, necessary for the stopping of the components 3, 34, can be designed in different and conventional ways. In the case of a component 3, the brake can arise from its drive itself, since this, in an appropriately regulated way is provided with voltage through its assigned individual control apparatuses 30a, 31a, . . . , 31b . . .

If one of the components, as described above, is formed by the apparatus 60 (component 34), then this can be braked by a controlled brake 44 (FIG. 2) responding over line 440 to central control apparatus 4, which acts with the aid of the time control 45. This brake 44 can also serve to halt, in a peremptory manner, the apparatus 60 within the specified speed limitations provided by the central control apparatus 4, and do this within the time period t_{Δ1}, while the controlled slowing down of the component 3 is taking place.

The control of the startup and accelerating speeds vₐ₃, vₛ₃, and vₐ₅, vₛ₅ is done in the above described manner utilizing the central control apparatus 4 and sectional control 41. In accord with the design of the control apparatuses 4, 41, 30a 31a, . . . , 30b, 31b . . . , 61, it is possible to retain in memory the program for the speed reduction sequence of a component 3, 34, as well as a program for their resumption of speed, possibly too, only in part. It is also a possibility to store the individual control apparatuses 30a 31a, . . . , 30b, 31b . . . , 61, so that, in coactive operation between, first, the central control apparatus 4 and the sectional control 41 and second, the individual control devices 30a 31a, . . . , 30b, 31b . . . , 61, the curves of the speed reduction or acceleration are under proper control. The individual control apparatuses 30a 31a, . . . , 30b, 31b . . . , 61 exhibit then corresponding input arrangements (not shown).

As FIG. 2 shows, not all components must be provided separately for each work station 10a, 11a . . . , 20a, 21a . . . , 10b, 11b . . . , 20b, 21b . . . Another possibility is to provide a single, common component 34 for all work stations 10a, 11a . . . , 20a, 21a . . . , on longitudinal machine side A as well as work stations 10b, 11b . . . , 20b, 21b . . . on longitudinal machine side B. Otherwise, per work station, 10a . . . , several components 3 may be provided, which, in the above demonstrated manner, can be controlled.

1. A process for the control of a component of a work station of a textile machine which possesses a plurality of similar and adjacent work stations, therein characterized, in that prespecified are
a first set speed for a preselected component during its normal operation,
a time period beginning at the start of a voltage loss, at the conclusion of which the component is to be shutdown, and
a second set speed which the component is to assume upon the runout of the said specified time period,
and upon said voltage loss, an auxiliary current source is activated and the speed of the components which are provided with auxiliary voltage from said current source, is reduced in a controlled manner with the aid of a prespecified program, within the limits of the determined time period in keeping with said input.

2. A process in accord with claim 1, therein characterized, in that upon renewed restoration of the application of the full voltage before the cessation of the specified time period, the components in a controlled or regulated manner are again brought up to the first set speed.

3. A process in accord with claim 1 or 2, therein characterized, in that the time period is specified to endure essentially up to 3 seconds.

4. A process in accord with claim 3, therein characterized, in that the time period is determined with dependency on the first set speed.

5. A process in accord with one or more of the claims 1 to 4, therein characterized, in that the component, for a second specified time period, is driven at an essentially constant speed, before it is accelerated in a controlled or regulated manner to the first set speed.

6. A process according to one or more of the claims 1 to 5, therein characterized, in that at the end of the first time period beginning at the end of the voltage failure, the component will run down without control.

7. A process in accord with claim 6, therein characterized, in that upon the end of the first time period beginning at the end of the voltage failure, the component will be braked.

8. A process in accord with one or more of the claims 1 to 7, therein characterized, in that before a renewed run-up of the component(s) (3, 34) the component(s) (3, 34) are brought into a specified ratio to one another.

9. A process in accord with one or more of the claims 1 to 8, therein characterized, in that the component (3, 34) and the individual or central control apparatus (4, 41, 30a 31a, 30b, 31b ,61) communicate with one another through a field bus system.

10. An apparatus for the control of a component of a work station of a textile machine which possesses a plurality of similar, adjacent work stations, with an individual control apparatus for the component as well as with a central control apparatus encompassing said individual control apparatuses in accord with one or more of the claims 1 to 9, therein characterized, and
in that the central control apparatus (4, 41) with one voltage monitor (50) overseeing the electrical voltage of a main power connection (5) and with a timing control (45). which is activated upon voltage failure for the determination of the shutdown point (t₂) for this component (3, 34) as well as being controllingly connected to an auxiliary current source (51) and in that the individual or central control apparatus (4, 41, 30a 31a, 30b, 31b ,61) possesses an input arrangement (46) to preprogram inputs for
a first set speed (vₐ₁, vₛ₁) for a present component (3, 34) during the normal spinning operation and
a second set speed (vₐ₂, vₛ₂) which the components assume (3, 34) upon reaching this previously determined cutoff time, and
in that further, a program has been input into the individual or into the central control apparatus (4, 41, 30a 31a, 30b, 31b ,61), by means of which the speed of the component (3, 34) which can now be supplied with voltage by the auxiliary current source (51) is now controllable because of the input set speeds (vₐ₁, vₛ₁, vₐ₂, vₛ₂) and the specified shutoff time (t₂).

11. An apparatus in accord with claim 1, therein characterized, in that the individual or the central control apparatus (4, 41, 30a 31a, 30b, 31b ,61) is so designed, that upon renewed restoration of the full voltage before the reaching of the preset shutoff time (t₂) as called for by the time controller (45), a controlled or regulated run-up of the component (3, 34) to its predetermined, first set speed (vₐ₁, vₛ₁) for normal operation is released.
